(19) United States
(12) Patent Application Publication
(10) Pub. No.: US 2005/0169955 A1
(43) Pub. Date: Aug. 4, 2005

(54) Storage stable mixture for CO2 generation

(76) Inventors: Miriam Simchoni Barak, D.N. Merom Hagalil (IL); Meir Shinitzky, Kfar Shmaryahu (IL); Gunter C. Muller, Freising (DE)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/772,216

(22) Filed: Feb. 4, 2004

(51) Int. Cl. A01N 65/00; A01N 63/04

(52) U.S. Cl. 424/410; 424/93.4; 424/93.5

(57) ABSTRACT

The invention relates to a method for attracting flying insects, particularly mosquitoes, for the purpose of trapping or killing them, which comprises releasing at least one chemical attractant for the insects including carbon dioxide, by reacting with water or other aqueous medium, a mixture of ingredients (such as sugar and yeast) which has previously been maintained in a substantially oxygen-free environment and which have the ability to interact with each other in presence of water or other aqueous medium, so as to generate the at least one chemical attractant. The invention also includes an essentially air-proof sealed package containing a mixture, substantially free of contact with oxygen, of the type described; the mixture also constitutes per se, an aspect of the invention.

### FIELD AND BACKGROUND OF THE INVENTION

The present invention relates a mixture of ingredients which interact in aqueous medium to generate insect attractant, a package containing the mixture, and a method for attracting flying insects by use of the mixture.

Many patents have been concerned with methods and apparatus for attracting and trapping (or killing) undesirable insects such as mosquitoes; see e.g., U.S. Pat. No. 6,516,559, and U.S. patent application Ser. No. 10/358,025, the inventors of which are also inventors of the present invention.

To the best of the present Applicants' knowledge, however, there has never been suggested in the past, use of a pre-packaged mixture of ingredients, having a viable shelf-life, which would enable the user to store the mixture and when required to produce insect attractant merely by contacting the mixture with water, in conjunction with a known system for attracting and trapping or killing insects, or even under primitive circumstances without any specialized apparatus.

Although ingredients of the type used in the present invention are used in the baking industry, they are generally used without pre-packaging. An exception has been described in GB Patent No. 792271, where a mixture of dried yeast and sugar is pre-packaged. However, it is clear from the present inventors' studies (see below), that merely packaging ingredients in absence of special conditions, would not give a product which could be used for attracting insects and at the same time would have viable storage characteristics.

It is a surprising discovery made by the present inventors, and even paradoxical, that in spite of the fact that microorganisms and suitable substrates are known to react anaerobically in presence of water, it is unnecessary to subject a microorganism/substrate mixture to absolutely anhydrous conditions in order to obtain a long shelf-life. Accordingly, it is a principal object of the present invention to provide a pre-packaged mixture of ingredients, having a viable shelf-life, which under prescribed conditions would have utility in attracting undesired insects. Other objects of the invention will be apparent from the description which follows.

### SUMMARY OF THE INVENTION

The present invention provides, in one aspect, a method for attracting flying insects (particularly mosquitoes) to a locus for the purpose of trapping or killing them, which comprises releasing in the vicinity of the locus at least one chemical attractant for the insects including carbon dioxide, by reacting with water or another aqueous medium, a mixture which has previously been maintained in a substantially oxygen-free environment and which comprises the following ingredients, namely, (a) at least one substrate and (b) at least one microorganism, which ingredients have the ability to interact with each other, either aerobically or anaerobically, or both, in presence of water or other aqueous medium, so as to generate the at least one chemical attractant.

In accordance with a particular embodiment of the method of the invention, the locus includes also at least one further attractant for the insects selected from chemical attractants other than those formed by the reaction with water or other aqueous medium, and physical attractants selected from heat, moisture, visible light, invisible electromagnetic radiation, optical shapes, color patterns, bodies or surfaces in motion, and any combinations thereof, with the effect that the insect attractant generated in accordance with the present invention is utilized together with one or more other insect attractants.

In another aspect, the invention provides an essentially air-proof sealed package containing a mixture, substantially free of contact with oxygen, comprising ingredients which have the ability to interact with each other, either aerobically or anaerobically, or both, in presence of water or other aqueous medium, so as to generate at least one chemical attractant for insects including carbon dioxide, said mixture comprising (a) at least one substrate and (b) at least one microorganism. Moreover, the mixture just defined also constitutes per se, an aspect of the present invention.

### BRIEF DESCRIPTION OF THE DRAWINGS

FIG. 1 shows loss of activity of a mixture packaged in accordance with an embodiment of the invention, in comparison with control.

FIG. 2-A shows average CO₂ release over a 24-hour period, from a mixture packaged in accordance with an embodiment of the invention.

FIG. 2-B shows the pulsed nature of CO₂ release, from a mixture packaged in accordance with an embodiment of the invention.

FIGS. 3 and 4 illustrate performance of the volatile attractants obtained from a mixture according to an embodiment of the invention without CO₂ in trapping Cx. pipiens and Ae. aegypti respectively.

FIG. 5 compares performance of CO₂ only, with combined attractants including CO₂, obtained from a mixture according to an embodiment of the invention, in trapping Cx. pipiens.

FIG. 6 compares performance of the Eco-Trap with and without attractant obtained from a mixture according to an embodiment of the invention, in trapping Ae. aegypti.

FIGS. 7 and 8 compare performance of the Eco-Trap and a UV-Trap in trapping Cx. pipiens or Ae. aegypti respectively, using attractant obtained from a mixture according to an embodiment of the invention.

### DETAILED DESCRIPTION OF THE INVENTION

The method, package and mixture of the invention may be further characterized by at least one of the following features:
(i) the at least one chemical attractant includes at least carbon dioxide, acetone and lactic acid;
(ii) the at least one substrate (a) comprises or consists of at least one sugar, and the at least one microorganism (b) comprises or consists of at least one yeast;
(iii) the mixture is supported on an inert carrier;
(iv) the mixture comprises additionally at least one added ingredient selected from antifoam, lactic acid and its salts, peptones, Jack Bean powder, yeast extracts, vitamin B2, phenylalanine and its salts, lysine and its salts, urea, and ammonium salts;
(v) the mixture includes at least one additional component selected from the group consisting of insecticides and pathogens for the insects;
(vi) said mixture is maintained in a substantially oxygen-free environment by vacuum or by contact with an inert gas environment;
(vii) said mixture is such that said at least one chemical attractant for the insects includes chemical attractants which are effective independently of the carbon dioxide.

The manner of release of the attractant can take different forms, as for example, by means of water or a simple aqueous medium in a cup, to water or an aqueous solution with a complex ventilation system to enhance breathing and fermentation.

The mixture may be supported on (e.g. embedded in) carrier substances, including absorbent materials such as paper, cardboard, sponge, fabric, foam, absorbent polymer, or sand, to be activated by the addition of water. To prepare the mixture in this form, all the ingredients except the microorganism are dissolved in water and then mixed with an excess of the absorbent (e.g. silica 10× by weight). Then the mixture is dried (e.g. under vacuum), and packaged together with the microorganism. The mixture (supported or otherwise) can be contacted with water for immediate release of attractant, or can be formulated for slow release over a period of time.

It may be noted that the CO₂ by itself or the other odiferous attractants produced according to the invention (such as lactic acid, acetone, alcohols (glycerin, acetic acid and other products, which can be identified as shown by gas chromatography) is/are sufficient to attract mosquitoes in significant numbers. The attractants other than CO₂ produced according to the invention can be collected and dissolved in water, ethanol, hexane or other solvents. These other attractants, if desired, can be absorbed on slow release substances, such as silica gel, fine sand and glass wool.

One or more of the produced attractants can be combined with other chemical attractants and/or physical attractants, with potential enhancement of their attraction to insects, such as mosquitoes, house flies or sand flies. As mentioned above, in an optional embodiment, the mixture can include one or more insecticides. A combination with insecticides reduces the amount of insecticide needed and reduces the area on which it has to be spread. Moreover, the mixture can include pathogens such as Bacillus turingensis to contaminate insects after attraction (to feeding stations or to sprayed areas) and consequently kill the same or their larva.

The following non-limiting experiments demonstrate the invention:

Improvement of Different Types of Mosquito Traps

The catch of mosquitoes and other blood sucking flies by selected commercial traps increases significantly with the help of the described mixture, if properly applied and attached to the examined trap. Mixture B (see below) was used in these experiments. Groups of 200 female mosquitoes (7 days old Cx. pipiens) were released in chambers of 40 m² and exposed to different traps. One trap was combined with the attractant diffused from a ventilation chamber, and the other one in its original state was the control. The results were as follows:

TABLE 1
Performance of different traps with the new attractant and without

| | Different traps with (++) or without (−−) attractant in release chamber | | | | | | | | | | | |
|---|---|---|---|---|---|---|---|---|---|---|---|---|
| | | | CDC | | MKIII | | Coleman | | | | Magnet | |
| | UV-Trap¹ | | Trap | | Lentek² | | pro³ | | Eco-Trap⁴ | | Defender⁵ | |
| Repetition | (−−) | (++) | (−−) | (++) | (−−) | (++) | (−−) | (++) | (−−) | (++) | (−−) | (++) |
| I | 22 | 53 | 58 | 75 | 79 | 88 | 55 | 73 | 39 | 84 | 68 | 77 |
| II | 15 | 47 | 67 | 102 | 61 | 100 | 43 | 55 | 44 | 91 | 55 | 62 |
| III | 38 | 89 | 48 | 88 | 85 | 98 | 39 | 61 | 27 | 68 | 79 | 85 |
| IV | 36 | 67 | 61 | 91 | 52 | 69 | 48 | 58 | 25 | 77 | 61 | 89 |
| Total No. | 111 | 256 | 234 | 356 | 277 | 355 | 185 | 247 | 135 | 320 | 263 | 313 |

| | | | | | | |
|---|---|---|---|---|---|---|
| percentage | +130% | +52% | +28% | +34% | 137% | +19% |

¹see e.g. U.S. Pat. No. 5,651,211
²see e.g. U.S. Pat. No. 6,662,489
³see e.g. U.S. Pat. Nos. 5,205,064; 5,799,436; 6,055,766; D466,578
⁴see U.S.S.N. 10/358,025
⁵see e.g. U.S. Pat. Nos. 6145,243; 6,286,249

Performance of Different Mixtures

Sugars in general (with the following types tested: sucrose, fructose, glucose, maltose or any combination of them) with yeast in general (baker's yeast, champagne yeast, wine yeast, brewer's yeast or any combination of them) react together in water, starting a fermentation/aerobic process.

The following mixtures A-E are non-limiting examples of the mixtures of the present invention. In all cases the powdered ingredients were mixed and packaged under nitrogen, using three layers of packaging material, namely 12 micron polyester (outer layer), 7-8 micron Aluminum, and 60 micron polyethylene, although in principle any packaging material giving an air-tight seal may be used for this purpose. The mixed materials had an average moisture content of generally below 6% by weight.

| | | |
|---|---|---|
| Substance | % of the mixture | quantities |

MIXTURE (A)

| | | |
|---|---|---|
| Baker's yeast | 21 | 16 g |
| Sucrose | 79 | 60 g |

MIXTURE (B)

| | | |
|---|---|---|
| Baker's yeast | 20.6 | 16 g |
| Sucrose | 77.2 | 60 g |
| Antifoam | 2.2 | 1.7 g |

MIXTURE (C)

| | | |
|---|---|---|
| Baker's yeast | 20 | 16 g |
| Sucrose | 75 | 60 g |
| Antifoam* | 2.5 | 2 g |
| Bacto-Peptone (Difco) | 1.9 | 1.5 g |
| Lactic acid, Ca or Na salt | 0.6 | 0.5 g |

MIXTURE (D)

| | | |
|---|---|---|
| Baker's yeast | 19.6 | 16 g |
| Sucrose | 73.4 | 60 g |
| Antifoam* | 2.1 | 1.7 g |
| Bacto-Peptone (Difco) | 1.8 | 1.5 g |
| Lactic acid, Ca or Na salt | 0.6 | 0.5 g |
| Jack Bean powder | 0.06 | 0.05 g |
| Urea | 0.12 | 0.1 g |
| Vitamin B2 | 0.006 | 0.005 g |
| Yeast extract** | 2.2 | 1.8 g |

MIXTURE (E)

| | | |
|---|---|---|
| Baker's yeast | 19.6 | 16 g |
| Sucrose | 73.4 | 60 g |
| Antifoam* | 2.1 | 1.7 g |
| Bacto-Peptone (Difco) | 1.8 | 1.5 g |
| Lactic acid, Ca or Na salt | 0.6 | 0.5 g |
| Jack Bean powder | 0.06 | 0.05 g |
| Urea | 0.12 | 0.1 g |
| Vitamin B2 | 0.006 | 0.005 g |
| Yeast extract** | 2.2 | 1.8 g |
| L-Phenylalanine | 0.006 | 0.005 g |
| L-Lysine | 0.0006 | 0.0005 g |
| Ammonium chloride | 0.0012 | 0.001 g |

*Antifoam powder (≧80% Ca) from EST Chemical Co. Ltd, Hangzhou, China.
**Extract of autolysed yeast cells (Difco)

While excellent results were achieved with a mixture of sucrose and baker's yeast (mixture A), adding antifoam avoids the otherwise extensive production of foam which can result in spill and improves the reaction in general (mixture B). The fermentation in presence or absence of air even of mixture A (and the other mixtures) produces and releases a blend of the following known insect attractants: CO₂, acetone, various alcohols, acetic acid, lactic acid and other organic acids. The formation of these specified and otherwise unspecified by-products can be demonstrated by gas chromatography. Mixture B is additionally improved by adding attractants that are already produced in the fermentation such as lactic acid (added as the Ca or Na salt), as well as peptone (mixture C). Mixture C is yet further improved by adding substances that are beneficial for the performance of the yeast such as Jack Bean powder, yeast extract, peptone and, vitamin B2 (mixture D). Mixture D is still further improved by adding attractants that are not produced in the fermentation process such as phenylalanine, lysine, urea, and/or ammonium salts (mixture E).

Method of evaluation In order to evaluate the performance of the different mixtures (contacted with water) they were exposed for comparison in the following devices to mosquitoes. Black stickers were fixed on alloy plates (20×20×0.5 cm) with a round opening (3 cm diameter) in the middle. The mixtures were ventilated with air in ventilation chamber and the resulting odors were released through the hole in the sticker. Batches of (mosquitoes) 100 females of Ae. aegypti and 100 females of Cx. pipiens were released in a room of 5×5×3 m. The mosquitoes were exposed overnight to the attractants from mixture A and mixture B separately. Each run was carried out 10 times, and repeated for the other mixtures.

Results of evaluation There was no significant difference in the attraction performance between mixtures A and B. Nevertheless, mixture B was easier to handle and allowed an even fermentation without unpredictable spills which was especially important if applied in ventilation chambers.

The experiment with mixture C showed a significant improvement over mixtures A and B; thus with C there were collected on average 21% more Cx. pipiens and 26% Ae. aegypti then with mixture B. The experiment with mixture D showed a further significant improvement—on average 29% more Cx. pipiens and 37% Ae. aegypti than mixture B. The experiment with mixture E showed a still further significant improvement—on average 41% more Cx. pipiens and 62% Ae. aegypti than mixture B.

Packaging the Mixture and Resulting Shelf Life

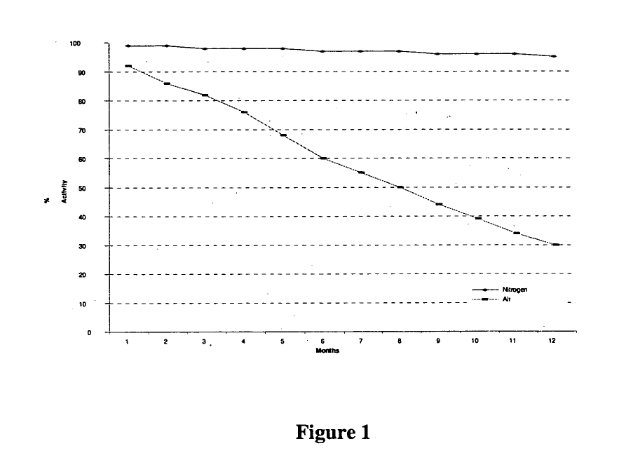

Different ways of packaging the mixture were compared. The mixture (B) was packed with plastic/metal foil laminate, either with nitrogen gas or in vacuum, and for comparison in air. The packages were kept in the same cool and dry environment over a period of 12 months. Tests on a monthly basis (15 repetitions for each substance) showed that the performance of the attractant, when the mixture was packaged with nitrogen or in vacuum, showed no significant difference and were satisfactory with an average loss of about 5% after 12 months. Material packed with the same laminated foil but without application of vacuum or nitrogen (i.e. in air) lost about 70% of its activity in the same period. Tests monitored CO₂ production and the performance with mosquitoes in experiments. Loss of activity of nitrogen- and air-packaged mixtures during a 12 month period are shown in FIG. 1. Mixture B (yeast, sucrose and antifoam) which was nitrogen packed and one year in storage was measured for CO₂ production as one parameter for activity. The change in CO₂ concentration (release) was measured at half hour intervals during 24 hrs. The CO₂ sensor was placed in the middle of a 2 liter cubic chamber with 4 release holes of 2 cm diameter in one of the side walls. The chamber was connected through its roof with a plastic tube (3 cm diameter 20 cm length) to a ventilated cartridge containing the mixture to which water had been added.

Average CO₂ Release of Nitrogen-Packed Mixture During 24 hrs.

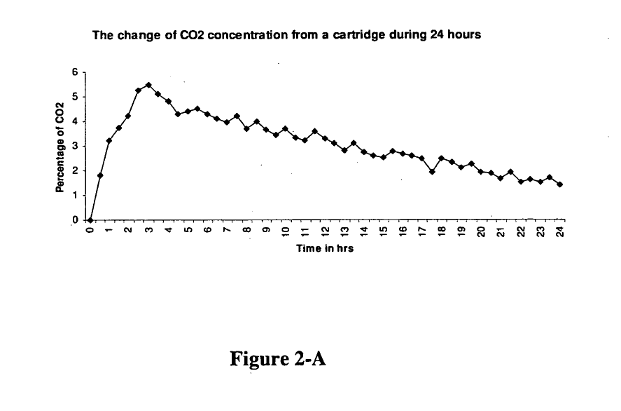

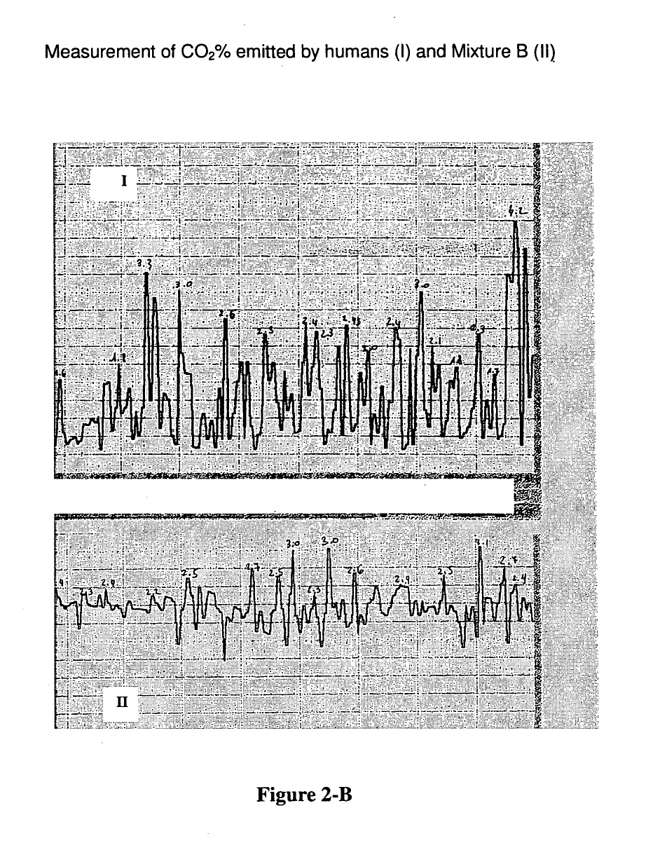

Air was passed through a ventilation chamber containing water-contacted mixture (B), and the quantity of CO₂ evolved over a 24-hour period was measured. The results are shown in FIG. 2-A.

Release of CO₂ and the Other Odors in Pulses

Also, as shown by the measurement of emitted CO₂, the gases are emitted from contact of water with mixture B, in natural pulses which simulate CO₂ released in pulses, and in similar concentrations, to those emitted by a human (see FIG. 2-B, showing emission of CO₂ over an approximately 50-minute period). The same amount of CO₂ released in pulses is known to be more attractive to insects than CO₂ released in an even manner.

Performance of the Volatile Attractants Without CO₂

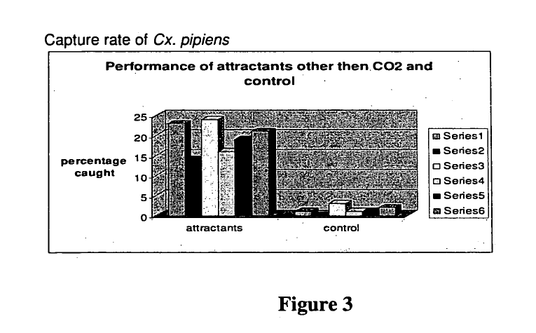

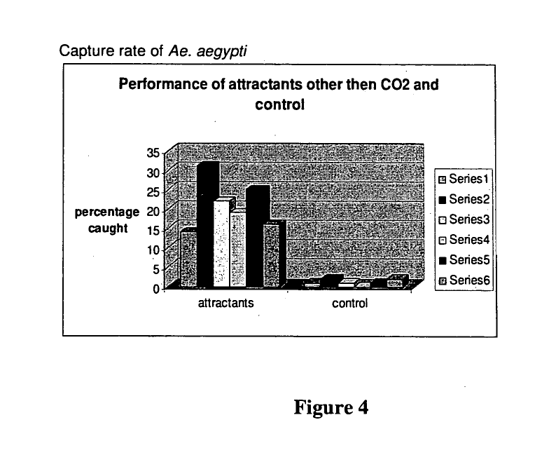

Dozens of identified and unidentified metabolic products of the fermentation with and without air have been demonstrated by gas chromatography. In a long series of experiments, these metabolic products were shown to be highly potent attractants by themselves even without CO₂. The gases emitted from a cartridge containing mixture (B), to which water had been added, were channeled through a bottle with 1 liter of 70% ethanol for 8 hrs. This bottle was then connected with a plastic tube (10 cm long 3 cm diameter) to a 20×20 cm sticky paper. The sticky paper was attached vertically to the bottle with the tube penetrating it in the middle. No CO₂ could be measured escaping from the thus-treated ethanol. Overnight, mosquitoes were exposed in the same room to this set up and a control unit with ethanol only. 100 female mosquitoes were released during each of the 6 runs. 100 female Cx. pipiens were released during each of the 6 repetitions, and the results are shown in FIG. 3. The results for a similar experiment on Ae. aegypti are shown in FIG. 4.

Performance of the Attractant Compared to CO₂ Only

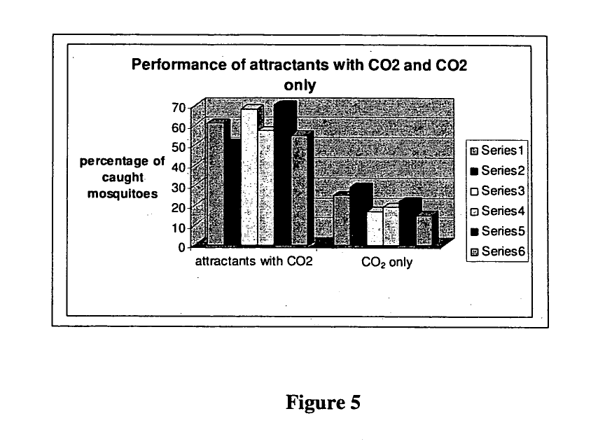

The level of CO₂ is about 3-5% of the emitted gases. This is the approximate percentage breathing mammals emit. The gases emitted by a ventilated cartridge containing mixture (B), to which water had been added, were channeled through a plastic tube (10 cm long 3 cm diameter) connected to a 20×20 cm sticky paper. The sticky paper was attached vertically to the bottle with the tube penetrating it in the middle. As a control the same setup was used, only no mixture was in the cartridge and instead of regular air an adjusted mixture of air and bottled CO₂ was channeled through the water. Overnight mosquitoes were exposed in the same room to the set up with the original cartridge and a control unit with a mixture of CO₂ only. 100 female Cx. pipiens were released during each of the 6 repetitions, and the results are shown in FIG. 5, from which it is clear that the combined attractants including CO₂ are far superior to CO₂ only.

Performance of the Eco-Trap with and Without Attractant

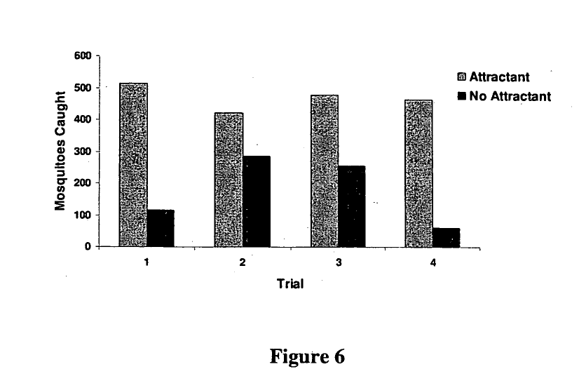

One thousand female mosquitoes (Ae. aegypti) were released into a 6000 ft chamber containing two Eco-Traps, one at each end of the chamber. The bait mixture was not present in one of the traps for comparison of efficacy with the bait-laden trap. In three trials both traps were allowed to run for one hour, after which the captured mosquitoes were counted and recorded. In the fourth trial, the traps were allowed to run overnight (16 hrs) and mosquitoes were treated as above. These experiments were carried out by the Insect Control and Research, Inc. Baltimore Md. Results are shown in FIG. 6. The Eco-Trap containing the attractant (from contacting mixture B with water) was significantly more efficient in catching mosquitoes, consistently capturing 40-50% of the mosquitoes present; 4.5 times as effective as the same trap without the attractants. It may be noted that together the two competing Eco-Traps caught in the trials over one hour an average of 69.1% of the mosquitoes.

Performance of Eco-Trap and a UV-Trap Catching Cx. pipiens or Ae. aegypti

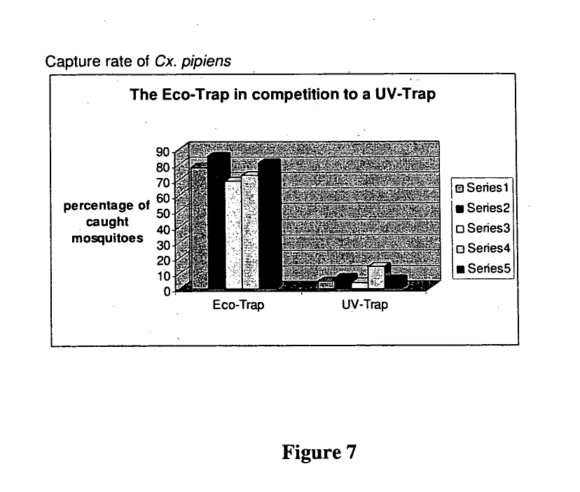

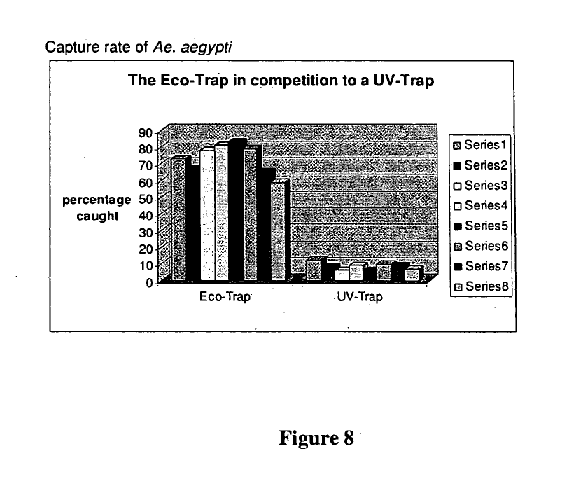

A production model of the Eco-Trap containing means for generating the attractant (from contacting mixture B with water) was compared to a current UV-Trap model (Gama Sonic model GS-006 Tel Aviv Israel) in controlled indoor release experiments with 100 sexed females of Cx. pipiens or Ae. aegypti. In five repetitions with Cx. pipiens the Eco-Trap outperformed the UV-Trap 5 to 11 times (see FIG. 7). In eight repetitions with Ae. aegypti the Eco-Trap outperformed the UV-Trap 6 to 15 times (see FIG. 8).

Indoor Controlled Release Tests with Cx. pipiens in the Presence of People

Controlled release test of Cx. pipiens and Ae. aegypti were done in numerous repetitions during the development of the prototype in Israel. In the presence of one to four persons trapping rates were 45-71% depending on the size and arrangements of rooms and apartments and the disposition of the people. These tests were used to refine the capture characteristics of the Eco-Trap. Final standardized tests of the manufactured units are under progress to document the efficiency of the unit.

Outdoor Capture Comparison Tests in Natural Habitats in Florida USA and Israel

Eco-Trap capture amounts were evaluated in Orange and Polk Counties in FL USA. Video taped testing in July 2002 showed that the sticky paper by itself rarely caught any mosquitoes while the full working trap with attractant (from contacting mixture B with water) caught within 45 minutes 300 plus mosquitoes. The heated-only trap without attractant caught less then 50 mosquitoes.

In Israel, all known genera of mosquitoes were collected in natural habitats. The habitats where the trap was tested included Mediterranean, Desert, Oasis and Marshland. In numerous repetitions the trap with the attractant outperformed the heated-only trap 7 to 18 times in the captures. The main genera of mosquitoes captured were Aedes and Culex. Anopheles and Culiseta were caught persistently but in small numbers. In suitable habitats several species of sand flies (Plebotomidae) were caught in large numbers. With sand flies the trap with the attractant outperformed the heated-only trap 3 to 7 times.

The entire contents of the patents and patent application mentioned in the present application are deemed incorporated herein by reference.

While the invention has been described with respect to specific embodiments including presently preferred modes of carrying out the invention, those skilled in the art will appreciate that there are numerous variations and modifications of the above described systems and techniques that fall within the spirit and scope of the invention.

1. A method for attracting flying insects to a locus for the purpose of trapping or killing them, which comprises releasing in the vicinity of the locus at least one chemical attractant for the insects including carbon dioxide, by reacting with water or other aqueous medium or other aqueous medium, a mixture which has previously been maintained in a substantially oxygen-free environment and which comprises the following ingredients, namely, (a) at least one substrate and (b) at least one microorganism, which ingredients have the ability to interact with each other, either aerobically or anaerobically, or both, in presence of water or other aqueous medium, so as to generate said at least one chemical attractant.

2. A method according to claim 1, which is further characterized by at least one of the following features:
(i) said at least one chemical attractant includes at least carbon dioxide, acetone and lactic acid;
(ii) said at least one substrate (a) comprises or consists of at least one sugar, and said at least one microorganism (b) comprises or consists of at least one yeast;
(iii) said mixture is supported on an inert carrier;
(iv) said mixture comprises additionally at least one added ingredient selected from antifoam, lactic acid and its salts, peptones, Jack Bean powder, yeast extracts, vitamin B2, phenylalanine and its salts, lysine and its salts, urea, and ammonium salts;
(v) said mixture includes at least one additional component selected from the group consisting of insecticides and pathogens for the insects;
(vi) said mixture is maintained in a substantially oxygen-free environment by vacuum or by contact with an inert gas environment;
(vii) said mixture is such that said at least one chemical attractant for the insects includes chemical attractants which are effective independently of the carbon dioxide;
(viii) the insects comprise mosquitoes;
(ix) said substantially oxygen-free environment is an essentially air-proof sealed package.

3. A method for attracting flying insects to a locus for the purpose of trapping or killing them, which comprises releasing in the vicinity of said locus at least one chemical attractant for the insects including carbon dioxide, by reacting with water or other aqueous medium or other aqueous medium, a mixture which has previously been maintained in a substantially oxygen-free environment and which comprises the following ingredients, namely, (a) at least one substrate and (b) at least one microorganism, which ingredients have the ability to interact with each other, either aerobically or anaerobically, or both, in presence of water or other aqueous medium, so as to generate said at least one chemical attractant; and wherein the locus includes also at least one further attractant for the insects selected from chemical attractants other than those formed by said reaction with water or other aqueous medium, and physical attractants selected from heat, moisture, visible light, invisible electromagnetic radiation, optical shapes, color patterns, bodies or surfaces in motion, and any combinations thereof.

4. A method according to claim 3, which is further characterized by at least one of the following features:
(i) said at least one chemical attractant includes at least carbon dioxide, acetone and lactic acid;
(ii) said at least one substrate (a) comprises or consists of at least one sugar, and said at least one microorganism (b) comprises or consists of at least one yeast;
(iii) said mixture is supported on an inert carrier;
(iv) said mixture comprises additionally at least one added ingredient selected from antifoam, lactic acid and its salts, peptones, Jack Bean powder, yeast extracts, vitamin B2, phenylalanine and its salts, lysine and its salts, urea, and ammonium salts;
(v) said mixture includes at least one additional component selected from the group consisting of insecticides and pathogens for the insects;
(vi) said mixture is maintained in a substantially oxygen-free environment by vacuum or by contact with an inert gas environment;
(vii) said mixture is such that said at least one chemical attractant for the insects includes chemical attractants which are effective independently of the carbon dioxide;
(viii) the insects comprise mosquitoes;
(ix) said substantially oxygen-free environment is an essentially air-proof sealed package.

5. An essentially air-proof sealed package containing a mixture, substantially free of contact with oxygen, comprising ingredients which have the ability to interact with each other, either aerobically or anaerobically, or both, in presence of water or other aqueous medium, so as to generate at least one chemical attractant for insects including carbon dioxide, said mixture comprising (a) at least one substrate and (b) at least one microorganism.

6. A package according to claim 5, which is further characterized by at least one of the following features:
(i) said at least one chemical attractant includes at least carbon dioxide, acetone and lactic acid;
(ii) said at least one substrate (a) comprises or consists of at least one sugar, and said at least one microorganism (b) comprises or consists of at least one yeast;
(iii) said mixture is supported on an inert carrier;
(iv) said mixture comprises additionally at least one added ingredient selected from antifoam, lactic acid and its salts, peptones, Jack Bean powder, yeast extracts, vitamin B2, phenylalanine and its salts, lysine and its salts, urea, and ammonium salts;
(v) said mixture includes at least one additional component selected from the group consisting of insecticides and pathogens for the insects;
(vi) said mixture is maintained in a substantially oxygen-free environment by vacuum or by contact with an inert gas environment;
(vii) said mixture is such that said at least one chemical attractant for the insects includes chemical attractants which are effective independently of the carbon dioxide.

7. A mixture substantially free of contact with oxygen, comprising ingredients which have the ability to interact with each other, either aerobically or anaerobically, or both, in presence of water or other aqueous medium, so as to generate at least one chemical attractant for insects including carbon dioxide, said mixture comprising (a) at least one substrate and (b) at least one microorganism.

8. A mixture according to claim 7, which is further characterized by at least one of the following features:
(i) said at least one chemical attractant includes at least carbon dioxide, acetone and lactic acid;
(ii) said at least one substrate (a) comprises or consists of at least one sugar, and said at least one microorganism (b) comprises or consists of at least one yeast;
(iii) said mixture is supported on an inert carrier;
(iv) said mixture comprises additionally at least one added ingredient selected from antifoam, lactic acid and its salts, peptones, Jack Bean powder, yeast extracts, vitamin B2, phenylalanine and its salts, lysine and its salts, urea, and ammonium salts;
(v) said mixture includes at least one additional component selected from the group consisting of insecticides and pathogens for the insects;
(vi) said mixture is maintained in a substantially oxygen-free environment by vacuum or by contact with an inert gas environment;
(vii) said mixture is such that said at least one chemical attractant for the insects includes chemical attractants which are effective independently of the carbon dioxide.
